(19) United States
(12) Patent Application Publication
(10) Pub. No.: US 2002/0067342 A1
(43) Pub. Date: Jun. 6, 2002

(54) Computer mouse

(76) Inventor: Kenneth W. Proper, Phoenix, AZ (US)

Correspondence Address: Tod R. Nissle, Esq., TOD R. NISSLE, P.C., P.O. Box 55630, Phoenix, AZ, 85078, US

(21) Appl. No.: 09/730,062

(22) Filed: Dec. 5, 2000

(51) Int. Cl. G09G 5/08

(52) U.S. Cl. 345/163

(57) ABSTRACT

A finger mounted computer mouse includes a ball which can be rotated with the user's thumb to move a cursor to different positions on a computer screen. The position of the mouse on the user's finger is adjusted by a second finger which is adjacent the finger on which the mouse is mounted. The ball can be used to click on areas of a computer screen over which the cursor is superimposed.

This invention pertains to computers.

More particularly, this invention pertains to a computer “mouse” which is utilized to move a cursor on the screen of a computer and is utilized to “click” on and select menus and other features on the computer screen.

In a further respect, the invention pertains to a computer mouse which is worn on the finger and which permits the orientation of the mouse on the finger to be readily manipulated to facilitate use of the mouse.

In another respect, the invention pertains to a computer mouse which can be worn by a user on a finger and easily utilized while the user types on a computer keyboard or other keyboard.

In still another respect, the invention relates to a computer mouse in which the ball functions both to adjust the position of the cursor on the computer screen and to click on selected features on the computer screen.

A conventional computer mouse includes at least one “left hand” button on top of the mouse and includes a ball on the bottom of the mouse. The mouse is about the size of an adult's hand and is readily grasped in the hand of a user. When the mouse is grasped and moved over a mouse pad or other surface, the ball rolls over the mouse pad. When the ball moves over the mouse pad, signals are generated which are transmitted to the computer associated with the mouse. The signals cause the cursor on the computer's viewing screen to move in the same direction as the mouse. When the cursor is positioned over an icon or other heading or symbol that appears on the computer screen, pressing or clicking the “left hand” button that is on the top of the mouse selects the icon. As is well known, the “left hand” button can also be “double-clicked” (clicked quickly twice in succession) to select menus or other features on the computer screen. Conventional computer mice also typically include another button on the right hand side of the top of the mouse which can be depressed to “right click” on an area of the computer screen over which the cursor is superimposed.

While a conventional computer mouse is practical and useful, one disadvantage of the mouse is that it requires the use of a hand. This means that while the user operates or holds the mouse, the user can not readily type. In order to address this problem, computer mice have been developed which are worn on a user's hand or fingers. Such mice, however, can be awkward to use because they are connected to a wire, because it is difficult to adjust the orientation of the mice on a user's finger, because they utilize buttons instead of a ball, and because the buttons on the mice are sometimes at a location which makes it difficult to operate the button with a thumb or other finger.

Accordingly, it would be highly desirable to provide an improved finger-mounted wireless computer mouse which permits the orientation of the mouse to be readily adjusted on a user's finger to facilitate operation of the mouse and to facilitate a user's typing while using the mouse, and, which permits the thumb or another finger to be readily utilized to operate the mouse,

Therefore, it is a principal object of the instant invention to provide an improved method and apparatus for controlling the movement of a cursor on a computer screen and for clicking on and selecting icons, menu items, and other commands on the screen of a computer.

A further object of the invention is to provide an improved finger-mounted computer mouse.

Another object of the invention is to provide an improved finger-mounted computer mouse the orientation of which can be readily manipulated after the mouse is mounted on the finger of a user.

Still a further object of the invention is to provide an improved finger-mounted computer mouse which can be conveniently operated using the thumb or another finger.

The foregoing and other, further and more specific objects and advantages of the invention will be apparent from the following detailed description of the invention, taken in conjunction with the drawings, in which:

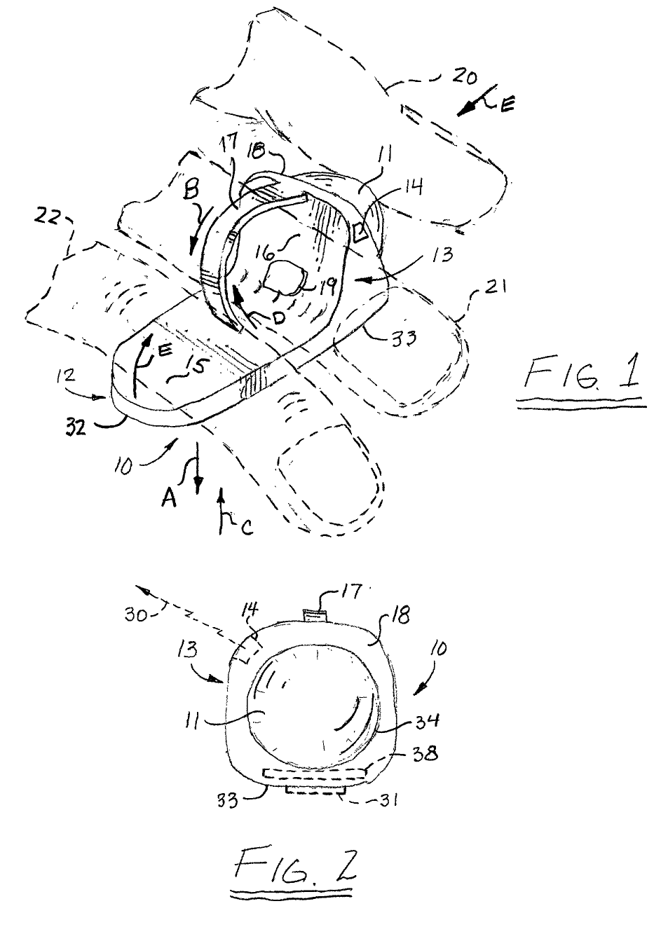

FIG. 1 is a perspective view illustrating a finger-mounted mouse constructed in accordance with the principles of the invention;

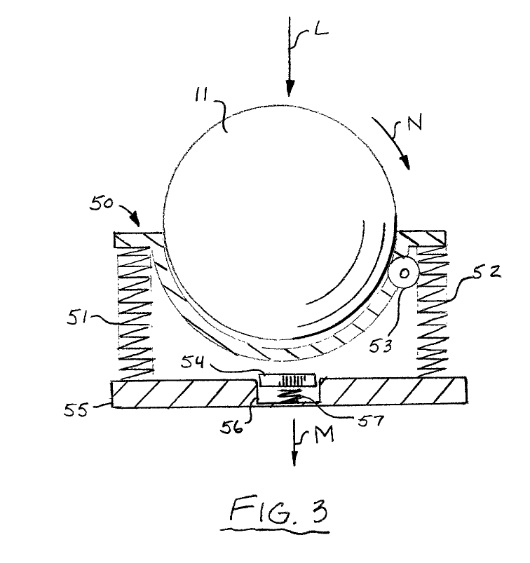

FIG. 2 is side view of the mouse of FIG. 1 further illustrating construction details thereof; and,

FIG. 3 is a side partial sectional view illustrating an embodiment of the invention in which the ball can be used both to move a cursor and to click to select an icon over which the cursor is positioned on the computer screen.

Briefly, in accordance with the invention, I provide an improved computer mouse for operation while worn on a user's finger. The mouse includes a ring shaped and dimensioned to engage the user's finger such that the ring can slidably rotate on the finger; and, a leg attached to the ring and shaped to extend outwardly from the ring and the user's finger such that a finger adjacent the user's finger can manipulate the leg to rotate the ring on the user's finger.

In another embodiment of the invention, I provide an improved computer mouse for operation by a user's thumb while worn on a user's finger. The mouse is operatively associated with a computer to position a cursor on a screen operatively associated with the computer. The mouse includes a ring shaped and dimensioned to engage the user's finger; and, a ball mounted on the ring such that the ball can be manipulated with the user's thumb to position the cursor on the computer screen.

In a further embodiment of the invention, I provide an improved computer mouse for operation by a user's thumb while worn on a user's finger. The mouse is operatively associated with a computer to position a cursor on a screen operatively associated with the computer. The mouse includes a ring shaped and dimensioned to engage the user's finger; and, a ball mounted on the ring such that the ball can be rotated with the user's thumb to position the cursor on the computer screen, and depressed with the user's thumb to click on a selected area on the computer screen.

In still another embodiment of the invention, I provide an improved method for positioning a computer mouse on a user's finger. The method includes the step of providing a computer mouse. The mouse includes a ring shaped and dimensioned to be mounted on the user's finger such that the ring can slidably rotate on the finger; and, a leg attached to the ring and shaped to extend outwardly from the ring and the user's finger such that a finger adjacent the user's finger can manipulate the leg to rotate the ring on the user's finger. The method also includes the steps of mounting the ring on the user's finger; and, using the fingers adjacent the user's finger to rotate the ring on the user's finger to a desired position.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a mouse 10 including a ring 17 connected to a body 13 and including a leg 12 extending outwardly from body 13. A ball 11 is mounted in the face 18 of body 13. Depressable button 19 is mounted in the inner surface 16 of body 13. A depressible button 31 (FIG. 2) can, if desired, be mounted on the bottom 33 of body 13 underneath ball 11.

Leg 12 includes upper surface 15 and bottom surface 32.

Atransmitter—receiver 14 is mounted in body 13. Transmitter-receiver 14 sends wireless signals 30. Signals 30 are generated when ball 11 is rotated in socket 34 by thumb 20 or another finger. Ball 11 can be rotated in any desired direction by thumb 20, much like the ball on the bottom of a conventional computer mouse can be rotated in any desired direction by moving the mouse over a mouse pad such that the ball frictionally contacts and rotates over the mouse pad. Ball 11 also serves as a “button” which can be depressed in the direction of arrow E to “click” on an icon, etc. in the same manner that a button is depressed on a conventional mouse to “click” or “double-click” on an icon or other symbol or command over which the cursor is positioned on a computer screen.

Ball 11 is, like the ball in a conventional computer mouse, operatively associated with sensors (usually, but not necessarily, at least a pair of sensors) which detect the direction of rotation of the ball and generate signals to transmitter 14. Transmitter 14 generates airborne or wireless signals 30 to a computer. The computer receives the airborne signals and uses the signals to move the cursor on the computer screen. Wireless mice and means for transmitting signals from the mice to a computer are well known in the art, and their structure and operation are not detailed herein.

As noted, ball 11 is also constructed such that ball 11 can be depressed to “click” or double click on an icon or other symbol(s) over which the cursor is positioned on the computer screen. Any desired construction can be utilized to permit ball 11 to perform the dual functions of being turned by thumb 20 to rotate ball 11 and to be depressed or compressed in the direction of arrow E to “click” on an icon or other area of a computer screen to which the cursor has been moved. After ball 11 is depressed to “click” on the area of a computer screen occupied by the cursor on the screen and is then released, ball 11 returns to its normal operative position, much like a spring-loaded button on a conventional computer mouse returns to its original operative position after it is depressed to click on an icon and is then released. When ball 11 is in its normal operative position, it can be rotated by thumb 21 to move the cursor on the computer screen.

Spring loaded buttons 19 and 31 are operated in the same manner that a button on a conventional computer mouse is operated. Depressing a button 19, 31 “clicks” on an icon or other area of a computer screen over which the cursor is positioned. After button 19, 31 is released, it returns to its normal operative position. “Double clicking” a button 19, 31 is accomplished in conventional fashion by depressing and releasing the button twice in quick succession.

When a button 19, 31 or ball 11 is depressed to produce a “click”, signals are generated in body 13 which travel to transmitter 14. Transmitter 14 sends airborne signals 30 to the computer associated with mouse 10. The signals are processed by the computer to produce a click which causes the selection of the icon or item over which the cursor is positioned. Since wireless mice are well known in the art, the apparatus and electronics necessary to generate signals by buttons 19, 31 (and ball 11), transmit signals 30 with transmitter 14, and process the signals by the computer associated with mouse 10 in order to “click” on a symbol on a computer screen are well known and will not be discussed herein.

In use, ring 17 is slipped over index finger 21 (or another desired finger) of a hand to a position over the outer or inner phalange of the finger such that ball 11 faces outwardly toward the thumb 20 of the hand. Ring 17 is preferably, but not necessarily, sized to comfortably but snugly encircle and fit finger 21. The middle finger 22 is positioned over the upper surface 15 of leg 12. Downwardly pressing against surface 15 with the middle finger 22 displaces leg 12 in the direction of arrow A and causes ring 17 to slide and rotate around finger 21 in the direction of arrow B. Positioning the middle finger 22 beneath leg 12 and pressing the middle finger upwardly against bottom surface 32 in the direction of arrow C causes ring 17 to slide and rotate around finger 21 in the direction of arrow D. In this manner, the middle finger 22 is used to adjust the position of ring 17 on index finger 21. Although it is not necessary for ring 17 to fit snugly on finger 21, if ring 17 does snugly fit finger 21, then the mouse 10 tends to remain in position after it is rotated around finger 21 by middle finger 22. The ability to adjust conveniently the position of mouse 10 on the finger 21 is important in the practice of the invention because it enables ball 11 and buttons 19, 31 to be moved to a position where they are more conveniently operated by thumb 20 or by another finger.

After middle finger 22 and leg 12 are used to rotate mouse 10 to a selected orientation on finger 21, thumb 20 can rotate ball 11 to move the cursor on the viewing screen associated with mouse 10. Once the cursor has been moved to a desired position, mouse 11 can be depressed and “clicked” to select an icon or other symbol(s) over which the cursor is superimposed on the screen. Or, button 19 can perform this function and can be depressed and “clicked”. In another embodiment of the invention, when ball 11 is depressed and “clicks” it functions like the left hand button on a conventional mouse while button 19 functions like the right hand button on a conventional mouse, or vice-versa.

A wire can be attached to mouse 10 to provide the power necessary to operate the mouse 10 and/or to carry signals from mouse 10 to a computer. It is, however, preferred that a battery be utilized to provide the electrical power necessary to operate the mouse.

The location of the ball 11 and buttons 19, 31 is important in the practice of the invention. Ball 11 is positioned on the side of finger 21 or another finger facing thumb 20, making ball 11 readily accessible to thumb 20. Button 19 is positioned beneath and in contact with finger 21 so button 19 can be readily operated by moving finger 21 only a minimal distance. Similarly, button 31 is in position immediately beneath ball 11 so that button 31 can be readily operated with and depressed. by thumb 20.

In order to insure that ring 17 snugly fits a finger of a user's hand, ring 17 can be provided in different sizes. The user picks the size that fits snugly and comfortably, or, if the user desired, that fits loosely and comfortably.

In FIG. 3, ball 11 is rotatably seated in a cup 50. When ball 11 is rotated in the direction of arrow N, roller 53 turns in the opposite direction. When roller 53 turns, it generates signals in conventional fashion. The signals are transmitted to a computer and indicate how a cursor moves on the computer screen. In most conventional mice a second roller (not visible) positioned in cup 50 ninety degree from roller 53 also detects the movement of ball. The second roller has a shape and dimension equivalent to that of roller 53. The second roller and roller 53 work cooperatively and detect rotational movement of the ball in any direction in a two axis coordinate system. Consequently, ball 11 can be rotated to make a cursor move in any desired two dimensional direction across a computer screen. When the user uses his thumb to depress ball 11 in the direction of arrow L, springs 51 and 52 are compressed against base 55, cup 50 is depressed in the direction of arrow L and depresses spring loaded button 54 downwardly in the direction of arrow M, “clicking” button 54 in the same manner that buttons on a conventional mouse are clicked. The wire attached to button 54 to transmit a signal to transmitter 14 when button 54 is clicked is omitted from FIG. 3 for the sake of clarity. The construction of “click” mouse buttons 54 and the transmission of electrical or other signals to a computer in response to a click is well known in the art and is not detailed herein.

Spring 57 returns button 54 to the normal operative position shown in FIG. 3 after ball 11 is pressed in the direction of arrow L and then released. Base 55, cup 50, springs 51 and 52, button 54, and spring 57 are mounted inside body 13.

The advantage of the ball construction illustrated in FIG. 3 is that ball 11 is used to perform the dual function of moving a cursor across a computer screen (which function is accomplished by rotating ball 11 with the thumb in the direction of arrow N or in any other desired direction) and of a “click” button (by depressing ball 11 in the direction of arrow L against button 54) so that an icon or other symbol(s) over which the cursor is positioned on the computer screen can be selected. In addition, when ball 11 is depressed in the direction of arrow L and button 54 is depressed, the pressure forcing ball 11 against 54 can be maintained by the user's thumb at the same time that the user's thumb is utilized to rotate ball 11 to move the cursor on the computer screen. The ball 11 and ball support apparatus can be constructed in the manner shown in FIG. 3 or can be constructed in any other desired manner as long as the dual functions of “clicking” and of moving the cursor on the computer screen can be performed by manipulating button 11.

In order to facilitate utilization of the invention, it is preferable that ball 11 be located in a position on body 13 which permits ball 11 to be readily manipulated with the thumb of the user which opposes the finger 21 on which the mouse of the invention is worn. Ball 11 preferably laterally projects outwardly from the index finger toward thumb 20 in the manner shown in FIG. 1.

Having described my invention in such terms as to enable those of skill in the art to make and practice it, and having described the presently preferred embodiments thereof, I claim:

1. A computer mouse for operation while worn on a user's finger, the mouse including
(a) a ring shaped and dimensioned to engage the user's finger such that the ring can slidably rotate on the finger; and,
(b) a leg attached to said ring and shaped to extend outwardly from said ring and said user's finger such that a finger adjacent the user's finger can manipulate said leg to rotate said ring on the user's finger.

2. A computer mouse for operation by a user's thumb while worn on a user's finger, the mouse operatively associated with a computer to position a cursor on a screen operatively associated with the computer, the mouse including
(a) a ring shaped and dimensioned to engage the user's finger; and,
(b) a ball mounted on said ring such that said ball can be manipulated with the user's thumb to position the cursor on the computer screen.

3. A computer mouse for operation by a user's thumb while worn on a user's finger, the mouse operatively associated with a computer to position a cursor on a screen operatively associated with the computer, the mouse including
(a) a ring shaped and dimensioned to engage the user's finger; and,
(b) a ball mounted on said ring such that said ball can be
(i) rotated with the user's thumb to position the cursor on the computer screen, and
(ii) depressed with the user's thumb to click on a selected area on the computer screen.

4. A method for positioning a computer mouse on a user's finger, including the steps of
(a) providing a computer mouse including
(i) a ring shaped and dimensioned to be mounted on the user's finger such that the ring can slidably rotate on the finger; and,
(ii) a leg attached to said ring and shaped to extend outwardly from said ring and said user's finger such that a finger adjacent the user's finger can manipulate said leg to rotate said ring on the user's finger;
(b) mounting said ring on the user's finger; and,
(c) using the fingers adjacent the user's finger to rotate said ring on the user's finger to a desired position.
